(19) United States
(12) Patent Application Publication
(10) Pub. No.: US 2026/0252914 A1
(43) Pub. Date: Aug. 27, 2026

(54) MACHINE LEARNING BASED SYSTEM AND METHOD FOR AUTOMATIC DATA RECONCILIATION

(71) Applicant: HIGHRADIUS CORPORATION, Houston, TX (US)

(72) Inventors: Sanjeev Suman, Hyderabad (IN); Sidharth Gupta, Hyderabad (IN); Murali Mohan Reddy Dodda, Hyderabad (IN); Prasanna Boni, Hyderabad (IN)

(21) Appl. No.: 19/060,821

(22) Filed: Feb. 24, 2025

(51) Int. Cl. G06N 5/025; G06F 16/23; G06F 16/28

(52) U.S. Cl. CPC G06N 5/025; G06F 16/2365; G06F 16/285

(57) ABSTRACT

A machine learning based (ML-based) method and system for automatic data reconciliation across multiple datasets, is disclosed. The process begins by obtaining inputs related to first data in a natural language, which are pre-processed to generate refined first data. An ML model is employed to generate first rules for a rule model based on this pre-processed first data, facilitating the matching of at least two datasets to identify second data comprising matched records. During subsequent matchings, the ML model analyses third data, consisting of unmatched records, to produce matching suggestions, confidence scores, and rationales. As the system evolves, it generates second rules informed by user feedback and ongoing matchings. The rule model is iteratively updated to enhance accuracy by examining correlations between first and second rules. Ultimately, this system provides users with efficient, automated, data reconciliation outputs, enabling improved integration and accuracy between at least two datasets.

### FIELD OF INVENTION

Embodiments of the present disclosure relate to machine learning based (ML-based) systems, and more particularly relates to a ML-based method and system for automatic data reconciliation.

### BACKGROUND

Data reconciliation between datasets refers to the process of identifying, comparing, and aligning data from different sources to ensure consistency, accuracy, and completeness. The data reconciliation involves detecting discrepancies, resolving conflicts, and ensuring that data values match across multiple datasets.

Typically, rule-based techniques are used for data reconciliation, which involve applying predefined rules to detect and resolve inconsistencies, discrepancies, or errors between the datasets. The rule-based techniques are commonly used in data integration, ETL (Extract, Transform, Load) processes, finance management, and data quality management.

However, the rule-based techniques have several drawbacks in the data reconciliation process. The rule-based techniques/approaches rely on predefined rules, making them inflexible when dealing with evolving or unexpected data discrepancies. The rule-based techniques may struggle with dynamic data sources or changing business rules. As data volume grows, maintaining and updating rule sets becomes increasingly complex and computationally expensive. The large datasets with diverse structures may require extensive rule definitions, leading to inefficiencies. Additionally, data reconciliation is often further complicated by data disparities arising from different sources or Enterprise Resource Planning (ERP) systems. The ERP systems typically present data in various formats, including differing units of measurement, date formats, or naming conventions, making direct matching a daunting task. This inconsistency not only hampers the reconciliation process but also introduces the risk of erroneous conclusions if not properly navigated.

Further, the rule-based techniques often fail when dealing with missing, inconsistent, or noisy data that does not fit the predefined rules. The rule-based techniques may not effectively detect errors that do not match existing patterns. Further, the rule-based techniques may require human intervention in manually creating and maintaining reconciliation rules. Hence, the process for adjusting the reconciliation rules for new data sources or formats is time-consuming and prone to errors. Further, rule-based systems may detect discrepancies but often lack mechanisms to infer correct values intelligently. The rule-based systems rely on predefined mappings, leading to false positives or undetected mismatches. The typical reconciliation rules may struggle with multi-source dependencies, hierarchical data structures, or probabilistic reconciliation, which leads to failure when relationships between data points are non-deterministic or require advanced reasoning. Running the reconciliation rules on the large datasets may slow down processing, especially when rules involve complex logic or multiple conditions. The rule-based systems have limited ability to learn from historical matches. The rule-based systems have limited ability to handle complex many-to-many relationships. The rule-based systems may utilize increased data volumes for reconciliation but with poor scalability. The rule-based systems may further require high maintenance costs for rule management.

Moreover, some matching scenarios involve complex criteria that necessitate a nuanced understanding of the contextual meaning behind the data. Traditional rule-based systems often fall short in these situations, as they lack the flexibility to interpret data intelligently, struggle with ambiguous matches, and may overlook subtle relationships that require a deeper level of analysis. Consequently, relying solely on rule-based approaches can lead to incomplete reconciliations and misinformed decision-making, highlighting the need for more advanced methodologies that can adeptly handle these complexities and improve overall data quality.

Alternatively, machine learning (ML) based techniques are used for data reconciliation with automation and adaptability. However, ML models heavily depend on clean and labelled training data. If input data is incomplete, inconsistent, or noisy, the ML model may learn incorrect patterns. Further, the ML based techniques may have challenges in handling mathematical operations correctly. The ML based techniques may have risk of hallucination in matching. Further, there might be computational complexity with the large datasets. The ML based techniques may have performance limitations with multiple computations.

Additionally, conventional large language model (LLM) techniques present significant challenges when utilized for automatic data reconciliation, particularly in the context of identifying, comparing, and aligning data from various sources to ensure consistency and accuracy. While rule-based techniques are typically employed for this purpose due to their structured approach, they often lack the flexibility needed to adapt to evolving discrepancies in dynamic datasets. LLMs, while capable of processing complex text, struggle with structured data and may not effectively capture the contextual nuances necessary for recognizing discrepancies that fall outside predefined rules. Moreover, conventional LLMs face difficulties in managing noisy or incomplete data, potentially leading to misalignments and incorrect inferences. This challenge is compounded by their limited ability to learn from historical matches or handle complex relationships inherent in large datasets. Furthermore, the computational requirements of running these models on substantial volumes of data can hinder processing efficiency, particularly when dealing with intricate reconciliation logic.

Hence, there is a need for an improved machine learning based (ML-based) system and method for automatic data reconciliation, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatic data reconciliation, is disclosed. The ML-based method further comprises obtaining, by one or more hardware processors, one or more inputs associated with first data from one or more databases. The one or more inputs comprise at least one of: one or more entity-specific instructions and one or more historical matched records from at least two datasets.

The ML-based method further comprises pre-processing, by the one or more hardware processors, the one or more inputs associated with the first data to generate pre-processed first data.

The ML-based method further comprises generating, by the one or more hardware processors, one or more first rules for a rule model using a machine learning (ML) model, based on the generated pre-processed first data.

The ML-based method further comprises applying, by the one or more hardware processors, the generated one or more first rules for matching the at least two datasets using the rule model to determine second data between the at least two datasets. The second data comprise matched data between the at least two datasets.

The ML-based method further comprises processing, by the one or more hardware processors, third data for one or more subsequent matchings among the at least two datasets, to generate at least one of: one or more matching suggestions, one or more confidence scores and one or more reasonings for the one or more matching suggestions, during each subsequent match, using the ML model. The third data comprise unmatched data between the at least two datasets.

The ML-based method further comprises generating, by the one or more hardware processors, one or more second rules for the rule model, upon performing the one or more subsequent matchings using at least one of: the ML model and one or more users.

The ML-based method further comprises updating, by the one or more hardware processors, the rule model based on correlation between the one or more first rules and the one or more second rules.

The ML-based method further comprises providing, by the one or more hardware processors, data reconciliation between the at least two datasets based on the updated rule model, as an output to the one or more users through one or more interfaces associated with one or more electronic devices of the one or more users.

In an embodiment, processing the third data for one or more subsequent matchings among the at least two datasets, comprises: (a) obtaining, by the one or more hardware processors, the at least two datasets with a set of configurations, wherein the set of configurations comprise one or more threshold values for date and amount differences, for determining one or more matches; (b) pre-processing, by the one or more hardware processors, the third data associated with the at least two datasets, to generate pre-processed third data; (c) clustering, by the one or more hardware processors, transactions within the at least two datasets into one or more clusters, using the ML model; and (d) validating, by the one or more hardware processors, an accuracy of the one or more clusters using the transactions matched between the at least two datasets.

In another embodiment, clustering the transactions within the at least two datasets, using the ML model, by at least one of: (a) performing, by the one or more hardware processors, a one-to-one matching process between the transactions within the at least two datasets; (b) grouping, by the one or more hardware processors, the transactions by date and amount to identify the one or more clusters wherein a single transaction in a first dataset of the at least two datasets corresponds to a single transaction in a second dataset of the at least two datasets by applying an inner merge technique; (c) performing, by the one or more hardware processors, at least one of: a one-to-many matching process and a many-to-one matching process, to identify the one or more clusters wherein the single transaction in the first dataset corresponds to multiple transactions in the second dataset by applying combinatorial search techniques; and (d) performing, by the one or more hardware processors, a many-to-many matching process to identify the one or more clusters wherein the multiple transactions in the first dataset correspond to the multiple transactions in the second dataset by applying advanced combinatorial search techniques.

In yet another embodiment, the ML-based method further comprises validating the accuracy of the one or more clusters with the matched transactions between the at least two datasets, by at least one of: (a) obtaining, by the one or more hardware processors, fourth data associated with the matched transactions, from the one or more clusters; (b) pre-processing, by the one or more hardware processors, the fourth data associated with the matched transactions to generate pre-processed fourth data; (c) generating, by the one or more hardware processors, one or more prompts for the ML model to determine confidence score per each identified cluster, wherein each prompt comprises information associated with at least one of: the matched transactions, user exceptions, and learnings from historical matched transactions; (d) generating, by the one or more hardware processors, the one or more reasonings for the one or more confidence scores for each identified cluster; and (e) optimizing, by the one or more hardware processors, a reliability of one or more results associated with the matched transactions, based on the determined one or more confidence scores, wherein the one or more results associated with the matched transactions indicate the accuracy of the one or more clusters, based on the determined one or more confidence scores.

In yet another embodiment, the ML-based method further comprises generating, by the one or more hardware processors, one or more actionable insights for the data reconciliation from the one or more results associated with the matched transactions, using the ML model, by: (a) obtaining, by the one or more hardware processors, fifth data associated with the one or more results corresponding to the matched transactions; (b) pre-processing, by the one or more hardware processors, the fifth data associated with the one or more results corresponding to the matched transactions, to generate pre-processed fifth data; (c) generating, by the one or more hardware processors, one or more prompts for the ML model for a process of instruction generation, per each identified cluster, wherein each prompt comprises information associated with at least one of: the matched transactions, the user exceptions, and learnings from historical instructions; (d) identifying, by the one or more hardware processors, at least one of: one or more patterns and one or more commonalities, by analyzing the data associated with the one or more results corresponding to the matched transactions; and (e) subsequently generating, by the one or more hardware processors, the one or more actionable insights and one or more instructions, based on at least one of: the one or more patterns and the one or more commonalities, using the ML model.

In yet another embodiment, the ML-based method further comprises: (a) aggregating, by the one or more hardware processors, the one or more actionable insights and the one or more instructions, into a set of guidelines related to the matched transactions; (b) converting, by the one or more hardware processors, the set of guidelines related to the matched transactions, into at least one of: one or more details, one or more substrings, one or more keywords, and one or more identifiers; (c) validating, by the one or more hardware processors, the set of guidelines related to the matched transactions; (d) storing, by the one or more hardware processors, the set of guidelines related to the matched transactions, in the one or more databases; (e) learning, by the one or more hardware processors, the set of guidelines by the ML model from the one or more databases, for optimizing the data reconciliation; and (f) updating, by the one or more hardware processors, the one or more databases based on the optimized data reconciliation performed by the learned ML model.

In yet another embodiment, generating the one or more second rules for the rule model, comprises: (a) obtaining, by the one or more hardware processors, sixth data from the one or more databases, wherein the sixth data comprise information associated with the one or more clusters with the matched transactions, generated for the one or more subsequent matchings; (b) pre-processing, by the one or more hardware processors, the sixth data associated with the one or more clusters, to generate pre-processed sixth data; (c) generating, by the one or more hardware processors, one or more prompts for the ML model for a process of rule generation, per each cluster of the one or more clusters, wherein each prompt comprises information associated with at least one of: the one or more clusters, historical rules, and user exceptions; (d) generating, by the one or more hardware processors, one or more match criteria by analyzing one or more key dimensions comprising at least one of: a date field, an amount field, and a text field; (e) generating, by the one or more hardware processors, at least one of: one or more date tolerances, one or more amount patterns, and one or more text operators, for each key dimension; and (f) consolidating, by the one or more hardware processors, at least one of: the one or more date tolerances, the one or more amount patterns, and the one or more text operators, to generate the one or more second rules for the one or more subsequent matchings between the at least two datasets.

In yet another embodiment, the ML-based method further comprises: (a) validating, by the one or more hardware processors, the one or more second rules for duplication of previously stored rules, based on one or more identifiers assigned to the one or more second rules; (b) determining, by the one or more hardware processors, whether the one or more results associated with the matched transactions exceed a pre-determined threshold value upon testing the validated one or more second rules on sample data; and (c) storing, by the one or more hardware processors, the validated one or more second rules in the one or more databases for future data reconciliation processes when the one or more results associated with the matched transactions exceed the pre-determined threshold value.

In one aspect, a machine learning based (ML-based) system for automatic data reconciliation, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises a data obtaining subsystem configured to obtain one or more inputs associated with first data from one or more databases. The one or more inputs comprise at least one of: one or more entity-specific instructions and one or more historical matched records from at least two datasets.

The plurality of subsystems further comprises a data pre-processing subsystem configured to pre-process the one or more inputs associated with the first data to generate pre-processed first data.

The plurality of subsystems further comprises a rules generating subsystem configured to generate one or more first rules for a rule model using a machine learning (ML) model, based on the generated pre-processed first data.

The plurality of subsystems further comprises a data processing subsystem configured to: (a) apply the generated one or more first rules for matching the at least two datasets using the rule model to determine second data between the at least two datasets, wherein the second data comprise matched data between the at least two datasets; and (b) process third data for one or more subsequent matchings among the at least two datasets, to generate at least one of: one or more matching suggestions, one or more confidence scores, and one or more reasonings for the one or more matching suggestions, during each subsequent match, using the ML model, wherein the third data comprise unmatched data between the at least two datasets.

The plurality of subsystems further comprises the rules generating subsystem configured to generate one or more second rules for the rule model, upon performing the one or more subsequent matchings using at least one of: the ML model and one or more users.

The plurality of subsystems further comprises a rules updating subsystem configured to update the rule model based on correlation between the one or more first rules and the one or more second rules.

The plurality of subsystems further comprises an output subsystem configured to provide data reconciliation between the at least two datasets based on the updated rule model, as an output to the one or more users through one or more interfaces associated with one or more electronic devices of the one or more users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRA WINGS

The disclosure will be described and explained with additional specificity and detail with the accompanying figures in which:

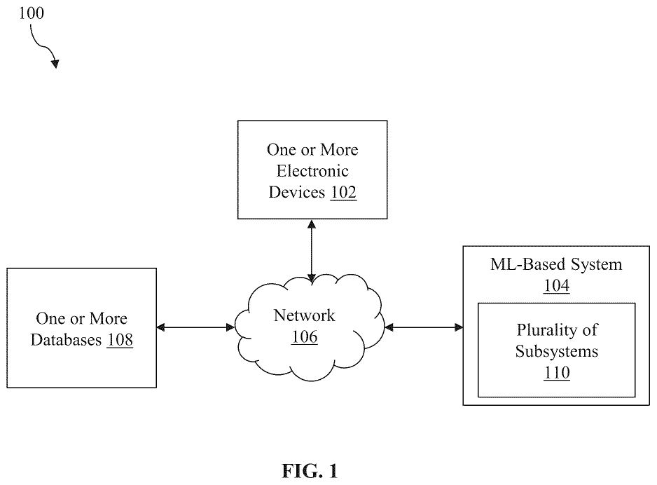

FIG. 1 is a block diagram illustrating a computing environment with a machine learning based (ML-based) system for automatic data reconciliation, in accordance with an embodiment of the present disclosure;

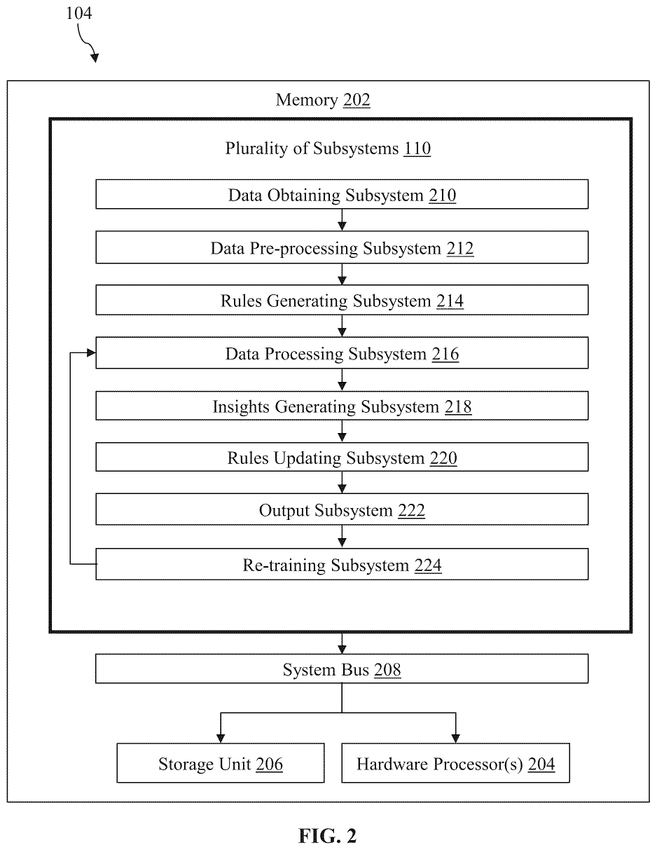

FIG. 2 is a detailed view of the ML-based system for the automatic data reconciliation, in accordance with another embodiment of the present disclosure;

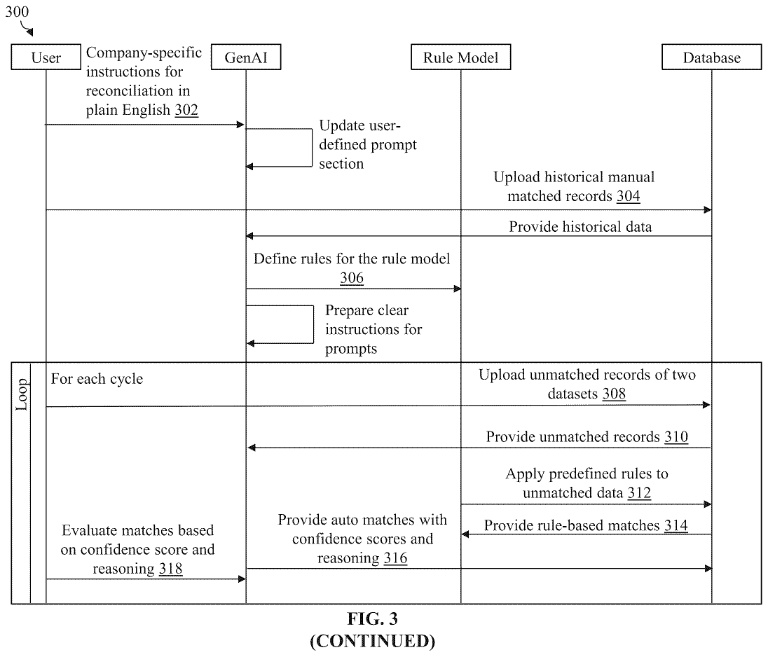

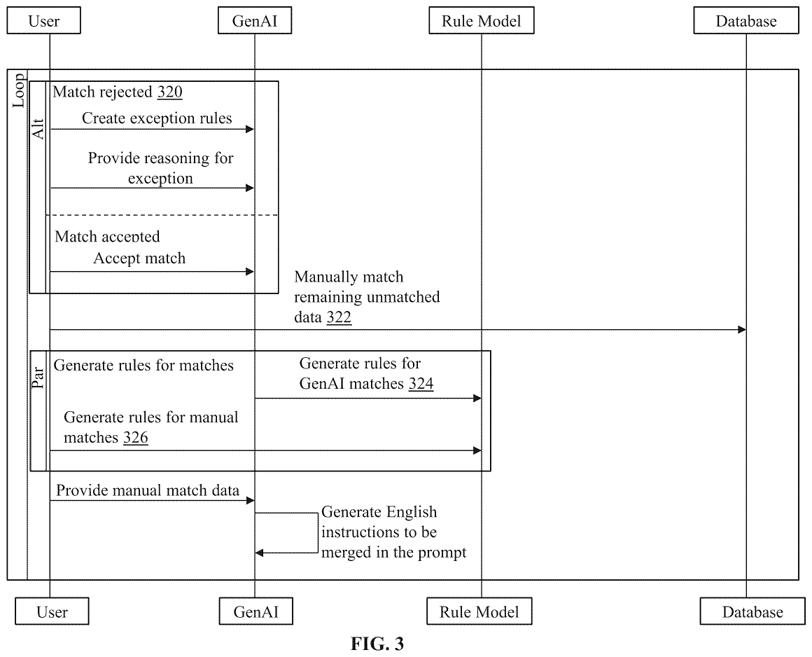

FIG. 3 is a high-level flow diagram of a data reconciliation process, in accordance with another embodiment of the present disclosure;

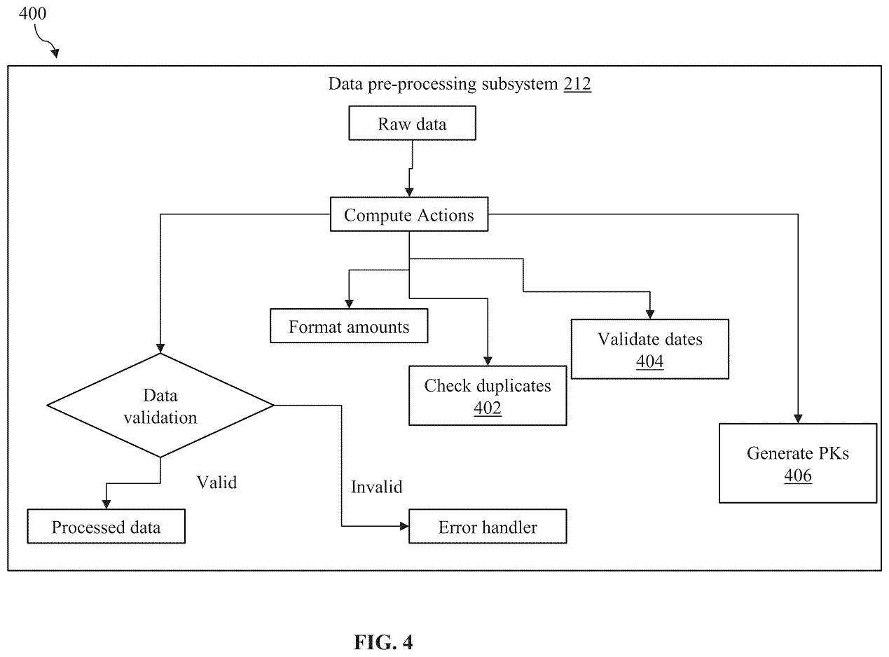

FIG. 4 is a flow diagram depicting a process of data pre-processing, in accordance with another embodiment of the present disclosure;

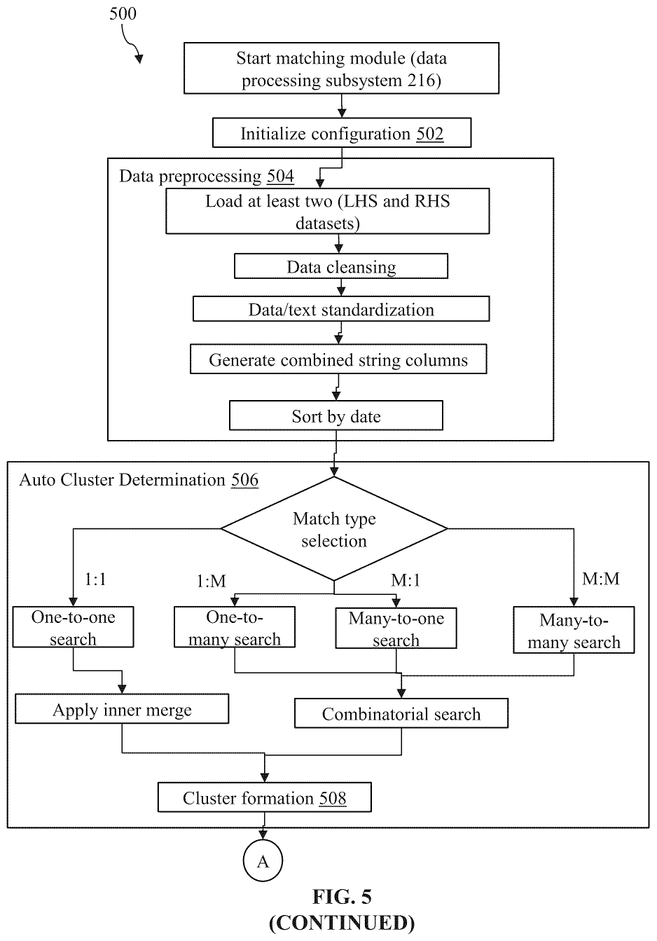

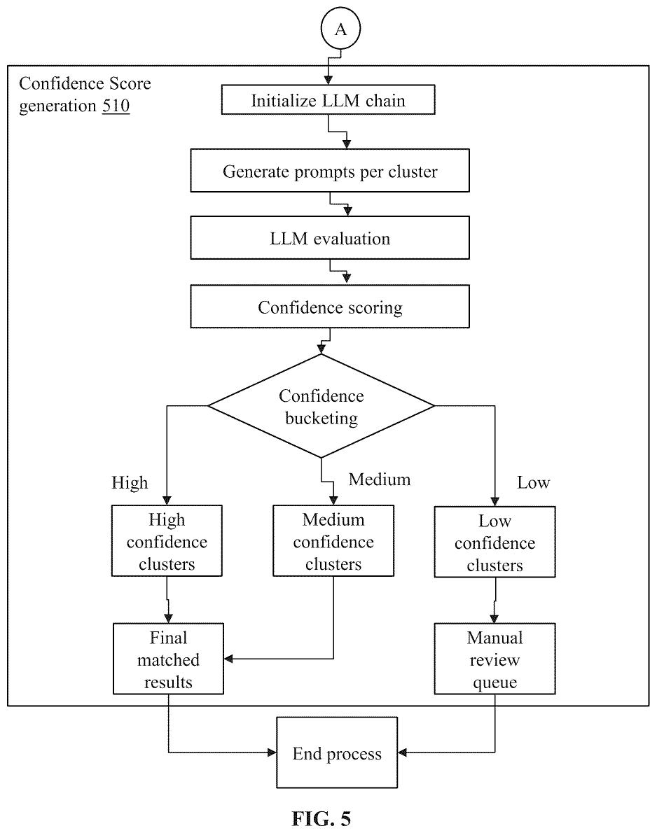

FIG. 5 is a flow diagram depicting processing of data for subsequent matchings among at least two datasets, in accordance with another embodiment of the present disclosure;

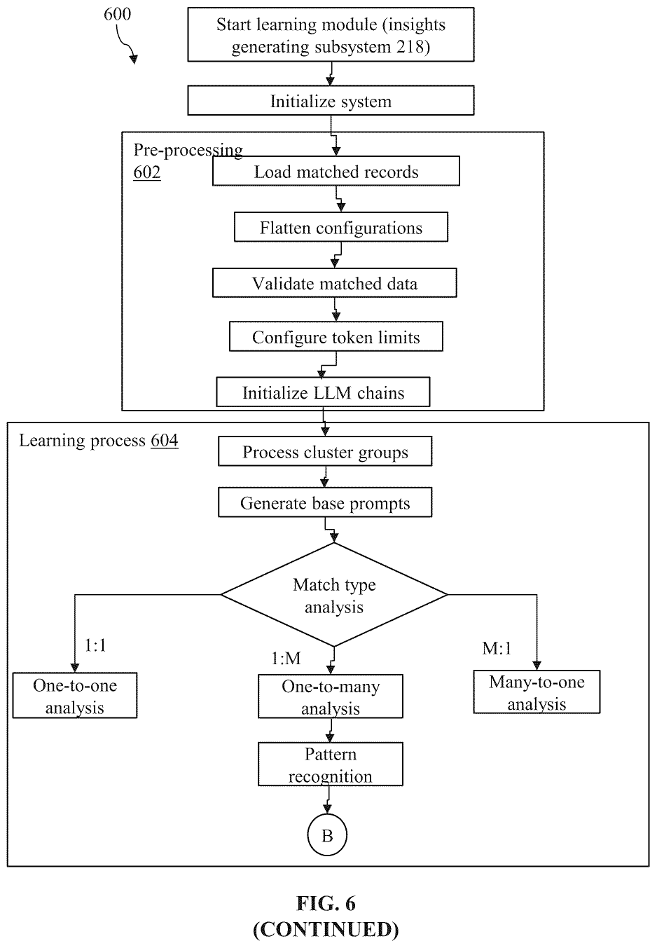

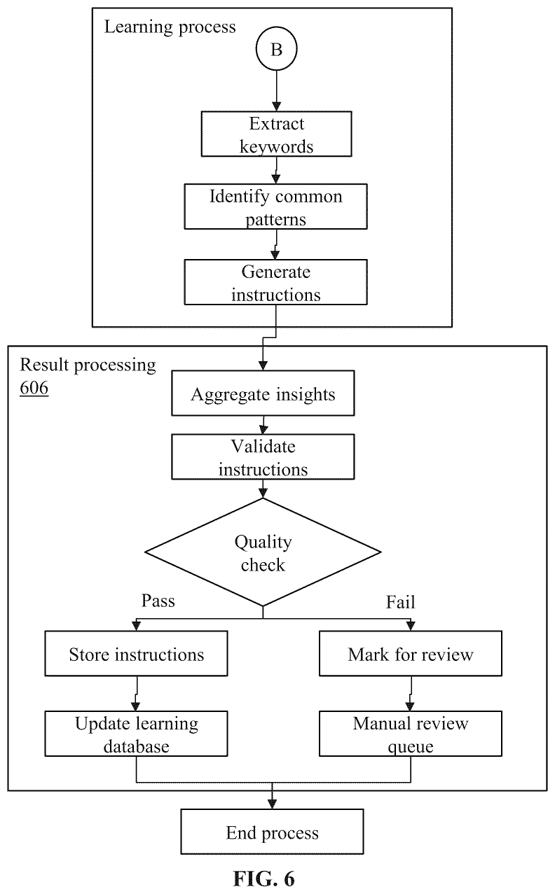

FIG. 6 is a flow diagram depicting generation of one or more insights learned by a machine learning (ML) model, in accordance with another embodiment of the present disclosure;

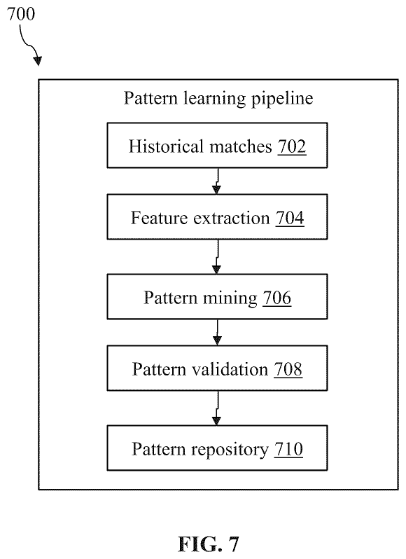

FIG. 7 is a flow diagram depicting a pattern learning pipeline, in accordance with another embodiment of the present disclosure;

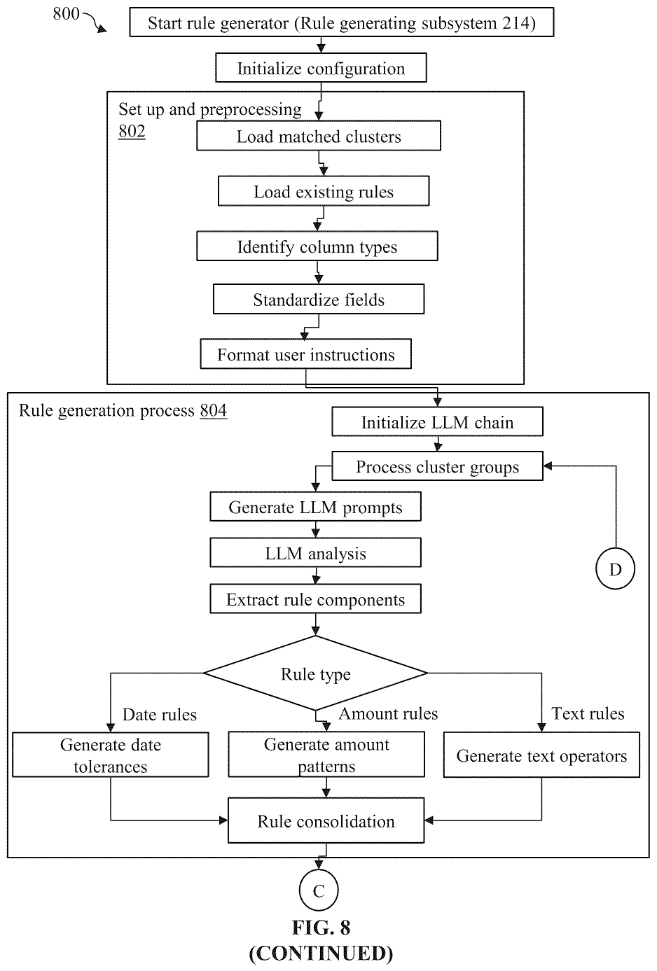

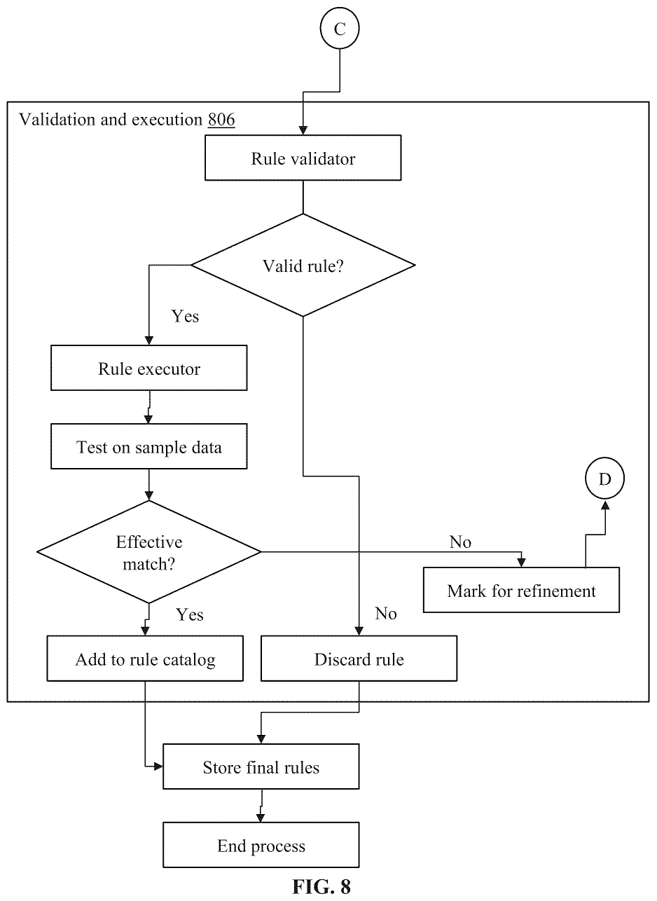

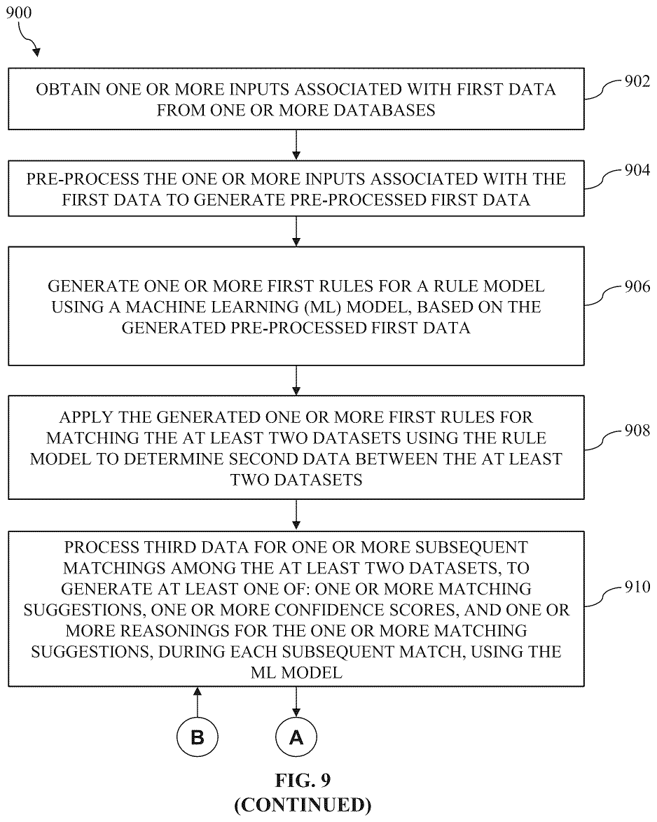

FIG. 8 is a flow diagram depicting generation of one or more rules for a rule model, in accordance with another embodiment of the present disclosure; and

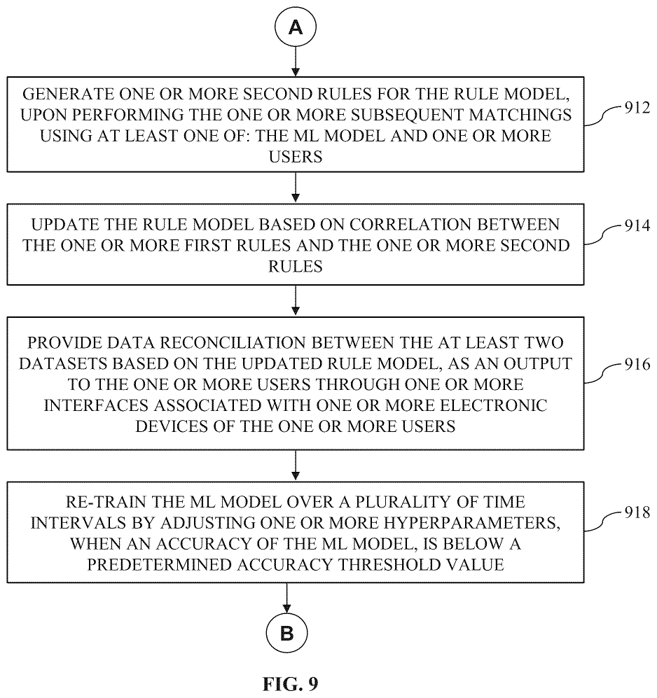

FIG. 9 is a flow chart illustrating a machine-learning based (ML-based) method for the automatic data reconciliation, in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

Referring now to the drawings, and more particularly to FIG. 1 through FIG. 9, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) system 104 for automatic data reconciliation, in accordance with an embodiment of the present disclosure. According to FIG. 1, the computing environment 100 includes one or more electronic devices 102 that are communicatively coupled to the ML-based system 104 through a network 106. The one or more electronic devices 102 through which one or more users receive output results from the ML-based system 104.

The present invention is configured to perform the automatic data reconciliation between at least two datasets. Here, the at least two datasets, are alternatively referred to as the “Left-Hand Side” (LHS) dataset and “Right-Hand Side” (RHS) dataset. In a financial context, an example of the LHS could be a company's invoice records, which detail the amount billed, the date of the invoice, and the recipient's information. The RHS, on the other hand, might represent a bank statement that lists the payments made, including the transaction date, amount, and corresponding invoice reference. The ML-based system 104 is initially configured to one or more inputs associated with first data from one or more databases 108. In an embodiment, the one or more inputs may include at least one of: one or more entity-specific instructions and one or more historical matched records from at least two datasets. In an embodiment, the one or more inputs may be encrypted and decrypted by the ML-based system 104, so that one or more third party users cannot be authenticated to manipulate the one or more inputs.

The ML-based system 104 is further configured to pre-process the one or more inputs associated with the first data to generate pre-processed first data. The ML-based system 104 is further configured to generate at least one of: one or more first rules for a rule model using a machine learning (ML) model, based on the generated pre-processed first data. The ML-based system 104 is further configured to apply the generated one or more first rules for matching the at least two datasets using the rule model to determine second data between the at least two datasets. In an embodiment, the second data may include matched data between the at least two datasets.

The ML-based system 104 is further configured to process third data for one or more subsequent matchings among the at least two datasets, to generate at least one of: one or more matching suggestions, one or more confidence scores and one or more reasonings for the one or more matching suggestions, during each subsequent match, using the ML model. In an embodiment, the third data may include unmatched data between the at least two datasets. The ML-based system 104 is further configured to generate one or more second rules for the rule model, upon performing the one or more subsequent matchings using at least one of: the ML model and one or more users.

The ML-based system 104 is further configured to update the rule model based on correlation between the one or more first rules and the one or more second rules. The ML-based system 104 is further configured to provide data reconciliation between the at least two datasets based on the updated rule model, as an output to the one or more users through one or more interfaces associated with the one or more electronic devices 102 of the one or more users.

In an embodiment, the one or more users may include at least one of: one or more data analysts, one or more business analysts, one or more cash analysts, one or more financial analysts, one or more collection analysts, one or more debt collectors, one or more professionals associated with cash and collection management, one or more customers, one or more organizations, one or more corporations, one or more parent companies, one or more subsidiaries, one or more joint ventures, one or more partnerships, one or more governmental bodies, one or more associations, and one or more legal entities, and the like.

The ML-based system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more databases 108 communicatively coupled to the ML-based system 104 through the network 106. In an embodiment, the one or more databases 108 may store the one or more documents. In an embodiment, the one or more databases 108 includes at least one of: one or more relational databases, one or more object-oriented databases, one or more data warehouses, one or more cloud-based databases, and the like. In another embodiment, a format of the data obtained from the one or more documents may include at least one of: a comma-separated values (CSV) format, a JavaScript Object Notation (JSON) format, an Extensible Markup Language (XML), spreadsheets, and the like.

Furthermore, the one or more electronic devices 102 include at least one of: a local browser, a mobile application, and the like. Furthermore, the one or more end users may use a web application through the local browser, the mobile application to communicate with the ML-based system 104. In an embodiment of the present disclosure, the ML-based system 104 includes a plurality of subsystems 110. Details on the plurality of subsystems 110 have been elaborated in subsequent paragraphs of the present description with reference to FIG. 2.

FIG. 2 is a detailed view of the ML-based system 104 for the automatic data reconciliation, in accordance with another embodiment of the present disclosure. The ML-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a data obtaining subsystem 210, a data pre-processing subsystem 212, a rules generating subsystem 214, a data processing subsystem 216, an insights generating subsystem 218, a rules updating subsystem 220, an output subsystem 222, and a re-training subsystem 224. The brief details of the plurality of subsystems 110 have been elaborated in a below table.

| Plurality of | |
|---|---|
| Subsystems 110 | Functionality |
| Data obtaining | The data obtaining subsystem 210 is configured to obtain the one |
| subsystem 210 | or more inputs associated with the first data from the one or more |
| | databases 108. |
| Data pre-processing | The data pre-processing subsystem 212 is configured to pre- |
| subsystem 212 | process the one or more inputs associated with the first data to |
| | generate the pre-processed first data. |
| Rules generating | The rules generating subsystem 214 is configured to generate |
| subsystem 214 | the one or more first rules for the rule model using the machine |
| | learning (ML) model, based on the generated pre-processed |
| | first data. |
| Data processing | The data processing subsystem 216 is configured to apply the |
| subsystem 216 | generated one or more first rules for matching the at least two |
| | datasets using the rule model to determine the second data |
| | between the at least two datasets. |
| | The data processing subsystem 216 is further configured to |
| | process the third data for the one or more subsequent matchings |
| | among the at least two datasets, to generate at least one of: the |
| | one or more matching suggestions, the one or more confidence |
| | scores, and the one or more reasonings for the one or more |
| | matching suggestions, during each subsequent match, using the |
| | ML model. |
| Insights | The insights generating subsystem 218 is configured to |
| generating | generate one or more actionable insights for the data |
| subsystem 218 | reconciliation from one or more results associated with |
| | matched transactions. |
| Rules generating | The Rules generating subsystem 214 is further configured to |
| subsystem 214 | generate the one or more second rules for the rule model, upon |
| | performing the one or more subsequent matchings using at least |
| | one of: the ML model and the one or more users. |
| Rules updating | The rules updating subsystem 220 is configured to update the |
| subsystem 220 | rule model based on correlation between the one or more first |
| | rules and the one or more second rules. |
| Output | The output subsystem 222 is configured to provide the data |
| subsystem 222 | reconciliation between the at least two datasets based on the |
| | updated rule model, as the output to the one or more users |
| | through the one or more interfaces associated with the one or |
| | more electronic devices 102 of the one or more users. |
| Re-training | The re-training subsystem 224 is configured to re-train the ML |
| subsystem 224 | model over a plurality of time intervals by adjusting one or |
| | more hyperparameters, when an accuracy of the ML model, is |
| | below a predetermined accuracy threshold value. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the data obtaining subsystem 210 that is communicatively connected to the one or more hardware processors 204. The data obtaining subsystem 210 is configured to obtain the one or more inputs associated with the first data from the one or more databases 108. In an embodiment, the one or more inputs may include at least one of: the one or more entity-specific instructions and the one or more historical matched records from the at least two datasets. In an embodiment, the one or more users may input the one or more entity-specific instructions and the one or more historical matched records, for the data reconciliation in a natural language (e.g., English). The natural language input may allow the ML-based system 104 to be tailored to specific instructions of one or more organizations of the one or more users.

In an embodiment, the ML-based system 104 allows the one or more users to upload the one or more historical matched records from the at least two datasets. The data associated with the at least two datasets may serve as training data for the ML model (e.g., generative AI engine).

The plurality of subsystems 110 includes the data pre-processing subsystem 212 that is communicatively connected to the one or more hardware processors 204. The data pre-processing subsystem 212 is configured to pre-process the one or more inputs associated with the first data to generate the pre-processed first data. The data pre-processing system 212 is a sophisticated system configured for preparing and standardizing the first data (e.g., financial transaction data). The data pre-processing system 212 is configured to employ an intelligent approach to data cleansing and normalization, specifically tailored to address the challenges of reconciling the data (e.g., financial records) from the one or more databases 108. The detailed description of the data-preprocessing subsystem 212 is explained in FIG. 4.

The plurality of subsystems 110 further includes the rules generating subsystem 214 that is communicatively connected to the one or more hardware processors 204. The rules generating subsystem 214 is configured to generate the one or more first rules for the rule model using the machine learning (ML) model, based on the generated pre-processed first data. The rules generating subsystem 214 is configured to utilize the one or more entity-specific instructions and the one or more historical matched records, to generate one or more prompts (i.e., clear instructions) for the ML model (e.g., GenAI engine). This ensures that the ML-based system 104 is aligned with the user's specific requirements and historical data patterns.

The plurality of subsystems 110 includes the data processing subsystem 216 that is communicatively connected to the one or more hardware processors 204. The data processing subsystem 216 is configured to apply the generated one or more first rules for matching the at least two datasets using the rule model to determine the second data between the at least two datasets. In an embodiment, the second data include the matched data between the at least two datasets. The data processing subsystem 216 is configured to process the third data for the one or more subsequent matchings among the at least two datasets, to generate at least one of: the one or more matching suggestions, the one or more confidence scores, and the one or more reasonings for the one or more matching suggestions, during each subsequent match, using the ML model. In an embodiment, the third data include the unmatched data between the at least two datasets.

For processing the third data for one or more subsequent matchings among the at least two datasets, the data processing subsystem 216 is configured to obtain the at least two datasets with a set of configurations. The set of configurations include one or more threshold values for date and amount differences, for determining one or more matches. The data processing subsystem 216 is configured to pre-process the third data associated with the at least two datasets, to generate pre-processed third data. The data processing subsystem 216 is configured to cluster transactions within the at least two datasets into one or more clusters, using the ML model. The data processing subsystem 216 is configured to validate an accuracy of the one or more clusters using the transactions matched between the at least two datasets.

The data processing subsystem 216 is configured to cluster transactions within the at least two datasets into one or more clusters based on various matching scenarios that can occur, including one-to-one, one-to-many, and many-to-one matches. As an example, in a one-to-one matching process, each invoice in the LHS has a corresponding entry in the RHS, allowing for straightforward reconciliation where each payment directly aligns with a single invoice. Conversely, in a one-to-many matching scenario, a single invoice in the LHS may correspond to multiple payments recorded in the RHS, this often occurs when a customer makes partial payments or multiple transactions against a single invoice, necessitating a more complex matching strategy to ensure all amounts are accounted for correctly. Similarly, in a many-to-one matching process, multiple invoices in the LHS may be paid by a single transaction in the RHS, for example, a lump-sum payment might cover several outstanding invoices from different suppliers. Understanding these matching scenarios is crucial for accurate data reconciliation.

For clustering the transactions within the at least two datasets, using the ML model, the data processing subsystem 216 is configured to initially perform a one-to-one matching process between the transactions within the at least two datasets. The data processing subsystem 216 is configured to group the transactions by date and amount to identify the one or more clusters wherein a single transaction in a first dataset of the at least two datasets corresponds to a single transaction in a second dataset of the at least two datasets by applying an inner merge technique. The Inner merge technique involves a straightforward one-to-one matching process where transactions are grouped based on shared attributes, such as date and amount, to efficiently identify clusters where a single transaction in the first dataset corresponds directly to a single transaction in the second dataset. This structured approach simplifies the identification of clear correlations between transactions.

The data processing subsystem 216 is further configured to perform at least one of: a one-to-many matching process and a many-to-one matching process, to identify the one or more clusters wherein the single transaction in the first dataset corresponds to multiple transactions in the second dataset by applying combinatorial search techniques. The data processing subsystem 216 is further configured to perform a many-to-many matching process to identify the one or more clusters wherein the multiple transactions in the first dataset correspond to the multiple transactions in the second dataset by applying advanced combinatorial search techniques. The combinatorial search techniques work by exploring various combinations and permutations of items within datasets to identify potential matches and relationships between them. Instead of relying on a straightforward one-to-one matching approach, this technique considers multiple scenarios where one transaction might correspond to several transactions in another dataset, or vice versa. These techniques often leverage algorithms to optimize the search process, allowing for the identification of subsets of transactions that match within specified thresholds.

For validating an accuracy of the one or more clusters with the matched transactions between the at least two datasets, the data processing subsystem 216 is initially configured to obtain fourth data associated with the matched transactions, from the one or more clusters. The data processing subsystem 216 is further configured to pre-process the fourth data associated with the matched transactions to generate pre-processed fourth data. The data processing subsystem 216 is further configured to generate one or more prompts for the ML model to determine confidence score per each identified cluster. In an embodiment, each prompt comprises information associated with at least one of: the matched transactions, user exceptions, and learnings from historical matched transactions.

The data processing subsystem 216 is further configured to generate the one or more reasonings for the one or more confidence scores for each identified cluster with the one or more reasonings. The data processing subsystem 216 is further configured to optimize a reliability of one or more results associated with the matched transactions, based on the determined one or more confidence scores. The one or more results associated with the matched transactions may indicate the accuracy of the one or more clusters, based on the determined one or more confidence scores.

The plurality of subsystems 110 further includes the insights generating subsystem 218 that is communicatively connected to the one or more hardware processors 204. The insights generating subsystem 218 is configured to generate one or more actionable insights for the data reconciliation from the one or more results associated with the matched transactions, using the ML model. For generating the one or more insights, the insights generating subsystem 218 is initially configured to obtain fifth data associated with the one or more results corresponding to the matched transactions. The insights generating subsystem 218 is further configured to pre-process the fifth data associated with the one or more results corresponding to the matched transactions, to generate pre-processed fifth data.

The insights generating subsystem 218 is further configured to generate one or more prompts for the ML model for a process of instruction generation, per each identified cluster. In an embodiment, each prompt includes information associated with at least one of: the matched transactions, the user exceptions, and learnings from historical instructions. The insights generating subsystem 218 is further configured to identify at least one of: one or more patterns and one or more commonalities, by analyzing the data associated with the one or more results corresponding to the matched transactions. The insights generating subsystem 218 is further configured to subsequently generate the one or more actionable insights and one or more instructions, based on at least one of: the one or more patterns and the one or more commonalities, using the ML model.

Upon generating the one or more insights, the insights generating subsystem 218 is further configured to aggregate the one or more actionable insights and the one or more instructions, into a set of guidelines related to the matched transactions. The insights generating subsystem 218 is further configured to convert the set of guidelines related to the matched transactions, into at least one of: one or more details, one or more substrings, one or more keywords, and one or more identifiers. The insights generating subsystem 218 is further configured to validate the set of guidelines related to the matched transactions. The insights generating subsystem 218 is further configured to store the set of guidelines related to the matched transactions, in the one or more databases 108. The insights generating subsystem 218 is further configured to learn the set of guidelines by the ML model from the one or more databases 108, for optimizing the data reconciliation. The insights generating subsystem 218 is further configured to update the one or more databases 108 based on the optimized data reconciliation performed by the learned ML model.

The rules generating subsystem 214 is configured to generate the one or more second rules for the rule model. For generating the one or more second rules, the rules generating subsystem 214 is initially configured to obtain sixth data from the one or more databases 108. The sixth data include information associated with the one or more clusters with the matched transactions, generated for the one or more subsequent matchings. The rules generating subsystem 214 is further configured to pre-process the sixth data associated with the one or more clusters, to generate pre-processed sixth data. The rules generating subsystem 214 is further configured to generate one or more prompts for the ML model for a process of rule generation, per each cluster of the one or more clusters. In an embodiment, each prompt comprises information associated with at least one of: the one or more clusters, historical rules, and user exceptions.

The rules generating subsystem 214 is further configured to generate one or more match criteria by analyzing one or more key dimensions comprising at least one of: a date field, an amount field, and a text field. The rules generating subsystem 214 is further configured to generate at least one of: one or more date tolerances, one or more amount patterns, and one or more text operators, for each key dimension. The rules generating subsystem 214 is further configured to consolidate at least one of: the one or more date tolerances, the one or more amount patterns, and the one or more text operators, to generate the one or more second rules for the one or more subsequent matchings between the at least two datasets.

Upon generating the one or more second rules, the rules generating subsystem 214 is configured to validate the one or more second rules for duplication of previously stored rules, based on one or more identifiers assigned to the one or more second rules. The rules generating subsystem 214 is further configured to determine whether the one or more results associated with the matched transactions exceed a pre-determined threshold value upon testing the validated one or more second rules on sample data. The rules generating subsystem 214 is further configured to store the validated one or more second rules in the one or more databases 108 for future data reconciliation processes when the one or more results associated with the matched transactions exceed the pre-determined threshold value.

The plurality of subsystems 110 further includes the rules updating subsystem 220 that is communicatively connected to the one or more hardware processors 204. The rules updating subsystem 220 is configured to update the rule model/engine based on the correlation between the one or more first rules and the one or more second rules.

The plurality of subsystems 110 further includes the output subsystem 222 that is communicatively connected to the one or more hardware processors 204. The output subsystem 222 is configured to provide the data reconciliation between the at least two datasets based on the updated rule model, as the output to the one or more users through the one or more interfaces associated with the one or more electronic devices 102 of the one or more users. In an embodiment, the entire reconciliation process is accessible and integrable via a Representational State Transfer Application Programming Interface (REST API) microservice. The REST API allows other systems to initiate reconciliation cycles, retrieve matched records, and handle exceptions programmatically. The API includes security measures and clear documentation to facilitate developer integration.

The plurality of subsystems 110 further includes the re-training subsystem 224 that is communicatively connected to the one or more hardware processors 204. In an embodiment, the re-training subsystem 224 is configured to re-train the re-train the ML model based on one or more feedback on the performance of the ML model, received from the one or more electronic devices 102 of the one or more users. In another embodiment, the re-training subsystem 224 is configured to re-train the ML-model over a plurality of time intervals by adjusting one or more hyperparameters, when an accuracy of the ML model, is below a predetermined accuracy threshold value.

FIG. 3 is a high-level flow diagram 300 of a data reconciliation process, in accordance with another embodiment of the present disclosure. At step 302, the ML-based system 104 receives the entity-specific instructions from the one or more electronic devices 102 of the one or more users. At step 304, the ML-based system 104 receives historical, manually matched records in the at least two datasets, from the one or more electronic devices 102 of the one or more users. At step 306, the ML-based system 104 utilizes at least one of: one or more entity-specific instructions and one or more historical matched records, to generate the one or more first rules for the rule model using the machine learning (ML) model, based on the generated pre-processed first data.

At step 308, the one or more users upload the unmatched data/records from the at least two datasets in the one or more databases 108. At step 310, the ML-based system 104 receives the unmatched records from the one or more databases 108. At step 312, the rule engine/model is configured to apply the one or more first rules (i.e., the one or more predefined rules) to the manually unmatched data. At step 314, the second data (matched data) are determined by the rule model between the at least two datasets and also the third data (i.e., the unmatched data from the rule model) is provided to the ML model.

At step 316, the third data (i.e., the unmatched data from the rule model) are processed to generate at least one of: one or more matching suggestions, one or more confidence scores, and one or more reasonings for the one or more matching suggestions during each subsequent match, using the ML model (e.g., GenAI engine). At step 318, the one or more users review the GenAI-provided matched, and evaluate the one or more matching suggestions, one or more confidence scores, and one or more reasonings. If the match is rejected, the ML-based system 104 generates an exception rule, along with documented reasoning for the rejection, as shown in step 320. This feedback loop is crucial for refining the accuracy of the ML-based system 104. In an embodiment, the one or more users may have an option to manually match the third data, as shown in step 322.

At step 324, the one or more second rules are generated for the rule model, upon performing the one or more subsequent matchings using the ML model. At step 326, the one or more second rules are generated for the rule model, upon performing the one or more subsequent matchings (i.e., manual matches) by the one or more users. The ML model learns from the manual matches to improve the prompts. This continuous learning of the matches ensures the ML-model become more accurate and efficient with each cycle.

FIG. 4 is a flow diagram 400 depicting a process of data pre-processing, in accordance with another embodiment of the present disclosure. The pre-processing of the data (e.g., the first data) may involve one of: amount standardization, duplicate handling, data-time normalization, and primary key management, and the like.

The data pre-processing subsystem 212, as shown in FIG. 2, is configured to incorporate a comprehensive suite of data transformation capabilities that work synergistically to ensure data integrity and consistency. The data pre-processing subsystem 212 is configured to utilize a multifaceted approach to data preparation, addressing common challenges encountered in financial data reconciliation.

For the amount standardization, the data pre-processing subsystem 212 is configured to employ advanced pattern recognition to extract numerical values from one or more formatting styles. The data pre-processing subsystem 212 is configured to manage diverse currency notations and representations. The data pre-processing subsystem 212 is configured to perform intelligent parsing of string-based amount fields. The data pre-processing subsystem 212 is configured to remove one or more non-numeric characters while preserving decimal precision, which are crucial for accurate financial matching.

For duplicate handling (as shown in 402), the data pre-processing subsystem 212 is configured to implement a sophisticated system to maintain data quality. The data pre-processing subsystem 212 is configured to identify and manage duplicates at both the record and field levels. The data pre-processing subsystem 212 is configured to perform features configurable retention policies. The data pre-processing subsystem 212 is configured to utilize a dual-layer duplicate detection approach to ensure data integrity while preserving essential transaction information.

For date-time normalization (as shown in 404), the data pre-processing subsystem 212 is configured to implement a sophisticated system to maintain data quality. The data pre-processing subsystem 212 is configured to incorporates an adaptive validation system. The data pre-processing subsystem 212 is configured to convert one or more date formats to a standardized representation. The data pre-processing subsystem 212 is configured to provide detailed diagnostics when encountering non-conforming dates. The data pre-processing subsystem 212 is configured to ensure temporal consistency across all records, vital for accurate transaction matching.

For primary key management (as shown in 406), the data pre-processing subsystem 212 is configured to implement an intelligent fallback mechanism. The data pre-processing subsystem 212 is configured to automatically generate unique identifiers when primary keys are missing or invalid. The data pre-processing subsystem 212 is configured to maintain referential integrity. The data pre-processing subsystem 212 is configured to provide a self-healing capability, ensuring that downstream matching processes have reliable reference points.

The components involved in the data pre-processing step are orchestrated through a centralized control system. The data pre-processing subsystem 212 is configured to maintain configuration state, which ensures consistent data transformation across the one or more data sources. In an embodiment, an architecture of the data pre-processing subsystem 212 allows for independent processing of the one or more data sources while maintaining a coherent transformation pipeline. The data pre-processing subsystem 212 is configured to manage one or more financial data formats effectively. The data pre-processing subsystem 212 is configured to maintain strict data quality standards. The data pre-processing subsystem 212 is configured to enhance the reliability of subsequent matching operations in financial reconciliation systems. The systematic approach to data preparation significantly improves the accuracy of matching operations. The formatted version provides a clear, structured overview of the data pre-processing subsystem 212, making it easier to understand its functions and importance within the larger reconciliation system.

FIG. 5 is a flow diagram 500 depicting processing of the data (e.g., the third data) for subsequent matchings among the at least two datasets, in accordance with another embodiment of the present disclosure. The data processing subsystem 216 is an advanced system configured to identify and cluster the matched transactions (i.e., matching financial transactions) originating from the at least two datasets (i.e., two distinct datasets). The data processing subsystem 216 is configured to employ sophisticated algorithms and configurable parameters to facilitate the accurate and efficient reconciliation of financial records. The primary objective is to determine the one or more clusters of matched transactions that exhibit correspondence based on various criteria, including but not limited to dates, amounts, and textual descriptions.

At step 502, the at least two datasets with a set of configurations, are obtained. In an embodiment, the set of configurations may include one or more threshold values for date and amount differences, for determining one or more matches.

At step 504, the data processing subsystem 216 with the help of the data pre-processing subsystem 212 is configured to pre-process the data (i.e., the third data) associated with the at least two datasets, to generate the pre-processed third data. For pre-processing data, the data pre-processing subsystem 212 is initially configured to obtain the at least two datasets. The data pre-processing subsystem 212 is further configured to remove one or more rows characterized by missing key values and select one or more requisite columns as defined by configuration settings. This ensures that only pertinent data are subjected to processing. The data pre-processing subsystem 212 is further configured to convert date columns to a standardized format, and text columns are cleansed to eliminate non-alphanumeric characters. This standardization is critical to ensure accurate matching.

The data pre-processing subsystem 212 is further configured to generate combined string column for each dataset by concatenating all text values. The combined column facilitates token-based matching, which contributes to the generation of confidence keywords. The data pre-processing subsystem 212 is further configured to sort the at least two datasets chronologically by date to enhance matching efficiency. This sorting methodology ensures that transactions are processed in a logical order, thereby optimizing the accuracy of the matching process.

At step 506, the transactions within the at least two datasets are clustered into the one or more clusters, using the ML model. For clustering the transactions within the at least two datasets, using the ML model, the data processing subsystem 216 is configured to perform match type selection process. The data processing subsystem 216 is configured to perform the one-to-one matching process between the transactions within the at least two datasets (i.e., left hand side dataset and right hand side dataset). The data processing subsystem 216 is configured to group the transactions by date and amount to identify the one or more clusters (as shown in step 508) wherein a single transaction in a first dataset of the at least two datasets corresponds to a single transaction in a second dataset of the at least two datasets by applying an inner merge technique. If thresholds are specified, the thresholds applied to further filter the matches.

For the transactions that do not yield the one-to-one match, the data processing subsystem 216 is configured to perform at least one of: the one-to-many matching process and the many-to-one matching process, to identify the one or more clusters (as shown in step 508) wherein the single transaction in the first dataset corresponds to multiple transactions in the second dataset by applying combinatorial search techniques. The data processing subsystem 216 is configured to utilize the combinatorial search techniques to identify subsets of the transactions that match the specified thresholds.

The data processing subsystem 216 is configured to perform the many-to-many matching process to identify the one or more clusters (as shown in step 508) wherein the multiple transactions in the first dataset correspond to the multiple transactions in the second dataset by applying advanced combinatorial search techniques. This constitutes the most complex matching scenario and necessitates the application of the advanced combinatorial search techniques to identify the optimal matching clusters.

At step 510, the data processing subsystem 216 is configured to validate the accuracy of the one or more clusters using the transactions matched between the at least two datasets.

The data processing subsystem 216 is an advanced system configured to assess and validate the accuracy of matched financial transaction clusters. The data processing subsystem 216 is configured to utilize sophisticated Large Language Model (LLM) to generates one or more confidence scores for each identified cluster, thereby optimizing the reliability of the matching process. The data processing subsystem 216 is seamlessly integrated within the broader reconciliation framework, providing comprehensive insights into the quality of the matches.

In other words, for validating the accuracy of the one or more clusters, the data processing subsystem 216 is configured to obtain the fourth data associated with the matched transactions, from the one or more clusters. The data processing subsystem 216 is configured to pre-process the fourth data associated with the matched transactions to generate pre-processed fourth data.

For pre-processing the fourth data, the data pre-processing subsystem 212 is initially configured to initialize data storage and retrieval paths, ensuring the matched data and the confidence scores are stored in appropriate locations. The data pre-processing subsystem 212 is configured to load the matched data from a CSV file. This matched data include the clusters of matched transactions that require confidence evaluation. The data pre-processing subsystem 212 is configured to flatten configuration dictionaries for enhanced accessibility and manipulation. This ensures all necessary configuration parameters are readily available for prompt generation and confidence evaluation.

The data processing subsystem 216 is then configured to generate the one or more prompts for the ML model to determine the confidence scores per each identified cluster. In an embodiment, each prompt includes the information associated with at least one of: the matched transactions, the user exceptions, and the learnings form the historical matched transactions. The data processing subsystem 216 is further configured to implement confidence buckets for classification purposes. These confidence buckets define thresholds for different confidence levels, enabling the data processing subsystem 216 to categorize confidence scores appropriately. The data processing subsystem 216 is further configured to generate the one or more reasonings for the one or more confidence scores for each identified cluster. The data processing subsystem 216 is further configured to optimize a reliability of one or more results associated with the matched transactions, based on the determined one or more confidence scores. The one or more results associated with the matched transactions indicate the accuracy of the one or more clusters, based on the determined one or more confidence scores. The one or more matches may be put in a manual review queue when the confidence score is low.

In an embodiment, the LLM's confidence scores and reasoning are aggregated into a results data frame, including metadata like cluster group UUID, processing time, and formatted confidence scores. The data processing subsystem 216 is configured to store the aggregated results to a CSV file, storing confidence scores and reasoning for further analysis and reporting.

FIG. 6 is a flow diagram 600 depicting the generation of one or more insights learned by the ML model, in accordance with another embodiment of the present disclosure.

The insights generating subsystem 218 is an advanced system configured to derive actionable insights and generate explicit instructions from matched transactions (i.e., matched financial transaction records). The insights generating subsystem 218 utilizes the sophisticated Large Language Model (LLM) to analyze the one or more clusters of matched records/transactions to produce concise, accurate, and readily implementable instructions for subsequent reconciliation tasks. The overarching objective is to facilitate continuous improvement of the reconciliation process by extracting knowledge from successful matches and formulating guidelines that enhance both accuracy and efficiency.

At step 602, the fifth data associated with the one or more results corresponding to the matched transactions, are pre-processed to generate the pre-processed fifth data.

For pre-processing of the fifth data associated with the one or more results corresponding to the matched transactions, the data pre-processing subsystem 212 is configured to flatten the configuration dictionaries to enhance data accessibility and manipulation. This step ensures that all essential configuration parameters are readily available for prompt generation and learning insights extraction. The data pre-processing subsystem 212 is further configured to generate preliminary prompts based on the job configuration and the flattened configurations. These preliminary prompts are tailored to the different match types and serve to guide the LLM in the subsequent learning insights extraction phase.

The data pre-processing subsystem 212 is further configured to define limits for the number of tokens per cluster group and the maximum completion tokens per cluster. These constraints ensure that the prompts remain within the acceptable processing limits of the LLM and that the generated instructions are concise and focused. The data pre-processing subsystem 212 is further configured to validate the matched data to confirm that it is non-empty and in a format suitable for learning insights extraction. This step is critical to ensure that the LLM has sufficient data for robust analysis and the generation of meaningful instructions. The data pre-processing subsystem 212 is further configured to initialize the LLM chain responsible for generating learning instructions. This chain includes the Language Model and the pre-generated prompts, enabling the LLM to effectively process the prompts and generate the desired learning insights.

At step 604, the insights generating subsystem 218 is then configured to generate one or more prompts for the ML model for a process of instruction generation, per each identified cluster. In an embodiment, each prompt includes the information associated with at least one of: the matched transactions, the user exceptions, and learnings from the historical instructions. This comprehensive prompt is then provided as input to the LLM.

The insights generating subsystem 218 with the LLM is configured to identify the one or more patterns and the one or more commonalities, by analyzing the data associated with the one or more results corresponding to the matched transactions. The insights generating subsystem 218 is configured to subsequently generating the one or more actionable insights and one or more instructions, based on at least one of: the one or more patterns and the one or more commonalities, using the ML model.

At step 606, the insights generating subsystem 218 is configured to aggregate the one or more actionable insights and the one or more instructions, into the set of guidelines related to the matched transactions. The insights generating subsystem 218 is configured to convert the set of guidelines related to the matched transactions, into at least one of: the one or more details, the one or more substrings, the one or more keywords, and the one or more identifiers. The insights generating subsystem 218 is configured to validate the set of guidelines related to the matched transactions. The insights generating subsystem 218 is configured to store the set of guidelines related to the matched transactions, in the one or more databases 108. The insights generating subsystem 218 is configured to learn the set of guidelines by the ML model from the one or more databases 108, for optimizing the data reconciliation. The insights generating subsystem 218 is configured to update the one or more databases 108 based on the optimized data reconciliation performed by the learned ML model. The set of guidelines related to the matched transactions are put in a manual review queue, when the set of guidelines related to the matched transactions are invalid.

FIG. 7 is a flow diagram 700 depicting a pattern learning pipeline, in accordance with another embodiment of the present disclosure. The one or more patterns are identified in the process of generating the one or more actionable insights. The one or more patterns associated with the matched transactions are identified from the historical matches (as shown in 702). One or more features are extracted (as shown in 704) from the historical matches and then the extracted one or more features are correlated with a pattern mining (as shown in 706) to determine one or more meaningful patterns associated with the matched transactions. The one or more meaningful patterns associated with the matched transactions are validated (as shown in 708) and stored in the pattern repository (as shown in 710).

FIG. 8 is a flow diagram 800 depicting generation of one or more rules (i.e., the one or more second rules) for the rule model, in accordance with another embodiment of the present disclosure. The rules generating subsystem 214 is an automated system configured for the discovery and refinement of matching rules between two distinct datasets. The rules generating subsystem 214 is configured to utilize the language models to analyze cluster groups of the matched records/transactions and identify potential matching criteria for future reconciliation tasks, based on observed patterns.

Initially, the sixth data are obtained from the one or more databases 108. The sixth data may include the information associated with the one or more clusters with the matched transactions, generated for the one or more subsequent matchings. At step 802, the sixth data associated with the one or more clusters, are pre-processed to generate the pre-processed sixth data. For pre-processing the sixth data associated with the one or more clusters, the data pre-processing subsystem 212 is configured to identify numeric, textual, and date columns. The data pre-processing subsystem 212 is further configured to ensure consistent references for each data field (primary key columns, date columns, text columns, etc.). The data pre-processing subsystem 212 is further configured to standardize user instructions or constraints to provide the language model with a clear job context.

At step 804, the rules generating subsystem 214 is configured to initiate the process by retrieving and storing references to one or more language model engines, data inputs, user configurations, and any pre-existing rules (referred to as existing rules). The rules generating subsystem 214 is configured to establish a working environment for output (e.g., file paths) and standardizes job details and instructions into a uniform format. The rules generating subsystem 214 is further configured to generate textual prompts for the ML model for a process of rule generation, per each cluster of the one or more clusters. In an embodiment, each prompt comprises information associated with at least one of: the one or more clusters, historical rules, and user exceptions. The textual prompts are utilized by the Large Language Model (LLM) to propose or refine matching rules. The text-based approach ensures that the rules reflect real-world data examples and any learned or known constraints. With the generated textual prompts, the rules generating subsystem 214 is configured to invoke a custom agent, which functions as an orchestrator for the LLM. The custom agent is equipped with specialized tools and parsers, enabling it to manage partial matches and convert the LLM's output into a structured JSON format.

The rules generating subsystem 214 is further configured to generate the one or more match criteria by analyzing the one or more key dimensions including at least one of: the date field, the amount field, and the text field. The rules generating subsystem 214 is further configured to generate at least one of: the one or more date tolerances, the one or more amount patterns, and the one or more text operators, for each key dimension. The rules generating subsystem 214 is further configured to consolidate at least one of: the one or more date tolerances, the one or more amount patterns, and the one or more text operators, to generate the one or more second rules for the one or more subsequent matchings between the at least two datasets.

At step 806, the rules generating subsystem 214 is further configured to validate the one or more second rules for duplication of previously stored rules, based on one or more identifiers assigned to the one or more second rules, using a rule validator. The rules generating subsystem 214 is further configured to determine whether the one or more results associated with the matched transactions exceed the pre-determined threshold value upon testing the validated one or more second rules on the sample data. The rules generating subsystem 214 is further configured to store the validated one or more second rules in the one or more databases 108 for future data reconciliation processes when the one or more results associated with the matched transactions exceed the pre-determined threshold value. If the one or more second rules are not validated, then the rules generating subsystem 214 again processes the cluster groups.

In an embodiment, the generation of rules and testing of the rules may enable iterative refinement of how two data sources are reconciled over time. The system includes components that interpret proposed rules, validate the rules against dataset columns and existing configurations, and ensure that the rules are compatible with the relevant domain-specific matching fields. This effectively verifies the accuracy and applicability of each rule before its inclusion in the rule catalog. Another set of functionalities executes the rule-driven matching, interfacing with an external matching engine (e.g., custom frameworks or standard matching libraries) using the validated rules. This confirms whether the generated rules can effectively match the target data.

FIG. 9 is a flow chart illustrating a machine-learning based (ML-based) method 900 for the data reconciliation, in accordance with an embodiment of the present disclosure.

At step 902, the one or more inputs associated with first data are obtained from the one or more databases 108. In an embodiment, the one or more inputs include at least one of: the one or more entity-specific instructions and the one or more historical matched records from the at least two datasets.

At step 904, the one or more inputs associated with the first data to generate pre-processed first data.

At step 906, the one or more first rules are generated for the rule model using the machine learning (ML) model, based on the generated pre-processed first data.

At step 908, the generated one or more first rules are applied for matching the at least two datasets using the rule model to determine the second data between the at least two datasets. In an embodiment, the second data may include the matched data between the at least two datasets.

At step 910, the third data for the one or more subsequent matchings among the at least two datasets, are processed to generate at least one of: the one or more matching suggestions, the one or more confidence scores and the one or more reasonings for the one or more matching suggestions, during each subsequent match, using the ML model. In an embodiment, the third data may include the unmatched data between the at least two datasets.

At step 912, the one or more second rules are generated for the rule model, upon performing the one or more subsequent matchings using at least one of: the ML model and the one or more users.

At step 914, the rule model is updated based on the correlation between the one or more first rules and the one or more second rules.

At step 916, the data reconciliation between the at least two datasets based on the updated rule model, is provided as the output to the one or more users through the one or more interfaces associated with the one or more electronic devices 102 of the one or more users.

At step 918, the ML model is re-trained over the plurality of time intervals by adjusting the one or more hyperparameters, when the accuracy of the ML model, is below the predetermined accuracy threshold value.

The present invention has following advantages. The present invention with the ML-based system 104 is configured to perform automatic the data reconciliation between the at least two datasets. The present invention with the ML-based system 104 is configured to achieve optimal reconciliation results while overcoming the limitations of both traditional rule-based systems with LLM-based matching. The present invention is configured to offer a significant advancement in financial reconciliation by combining the strengths of rule-based systems and Generative AI. The present invention has the potential to revolutionize how businesses manage and reconcile financial data, leading to increased efficiency, accuracy, and cost savings.

The present invention with the ML-based system 104 is configured to reduce manual intervention in the data reconciliation process. The present invention with the ML-based system 104 is configured to provide improved accuracy, reduced operational costs, in the data reconciliation process.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) method for automatic data reconciliation, the ML-based method comprising:
obtaining, by one or more hardware processors, one or more inputs associated with first data from one or more databases, wherein the one or more inputs comprise at least one of: one or more entity-specific instructions and one or more historical matched records from at least two datasets;
pre-processing, by the one or more hardware processors, the one or more inputs associated with the first data to generate pre-processed first data;
generating, by the one or more hardware processors, one or more first rules for a rule model using a machine learning (ML) model, based on the generated pre-processed first data;
applying, by the one or more hardware processors, the generated one or more first rules for matching the at least two datasets using the rule model to determine second data between the at least two datasets, wherein the second data comprise matched data between the at least two datasets;
processing, by the one or more hardware processors, third data for one or more subsequent matchings among the at least two datasets, to generate at least one of: one or more matching suggestions, one or more confidence scores and one or more reasonings for the one or more matching suggestions, during each subsequent match, using the ML model, wherein the third data comprise unmatched data between the at least two datasets;
generating, by the one or more hardware processors, one or more second rules for the rule model, upon performing the one or more subsequent matchings using at least one of: the ML model and one or more users;
updating, by the one or more hardware processors, the rule model based on correlation between the one or more first rules and the one or more second rules; and
providing, by the one or more hardware processors, data reconciliation between the at least two datasets based on the updated rule model, as an output to the one or more users through one or more interfaces associated with one or more electronic devices of the one or more users.

2. The ML-based method of claim 1, wherein processing the third data for one or more subsequent matchings among the at least two datasets, comprises:
obtaining, by the one or more hardware processors, the at least two datasets with a set of configurations, wherein the set of configurations comprise one or more threshold values for date and amount differences, for determining one or more matches;
pre-processing, by the one or more hardware processors, the third data associated with the at least two datasets, to generate pre-processed third data;
clustering, by the one or more hardware processors, transactions within the at least two datasets into one or more clusters, using the ML model; and
validating, by the one or more hardware processors, an accuracy of the one or more clusters using the transactions matched between the at least two datasets.

3. The ML-based method of claim 2, wherein clustering the transactions within the at least two datasets, using the ML model, by at least one of:
performing, by the one or more hardware processors, a one-to-one matching process between the transactions within the at least two datasets;
grouping, by the one or more hardware processors, the transactions by date and amount to identify the one or more clusters wherein a single transaction in a first dataset of the at least two datasets corresponds to a single transaction in a second dataset of the at least two datasets by applying an inner merge technique;
performing, by the one or more hardware processors, at least one of: a one-to-many matching process and a many-to-one matching process, to identify the one or more clusters wherein the single transaction in the first dataset corresponds to multiple transactions in the second dataset by applying combinatorial search techniques; and
performing, by the one or more hardware processors, a many-to-many matching process to identify the one or more clusters wherein the multiple transactions in the first dataset correspond to the multiple transactions in the second dataset by applying advanced combinatorial search techniques.

4. The ML-based method of claim 2, wherein validating the accuracy of the one or more clusters with the matched transactions between the at least two datasets, by at least one of:
obtaining, by the one or more hardware processors, fourth data associated with the matched transactions, from the one or more clusters;
pre-processing, by the one or more hardware processors, the fourth data associated with the matched transactions to generate pre-processed fourth data;
generating, by the one or more hardware processors, one or more prompts for the ML model to determine confidence score per each identified cluster, wherein each prompt comprises information associated with at least one of: the matched transactions, user exceptions, and learnings from historical matched transactions;
generating, by the one or more hardware processors, the one or more reasonings for the one or more confidence scores for each identified cluster; and
optimizing, by the one or more hardware processors, a reliability of one or more results associated with the matched transactions, based on the determined one or more confidence scores, wherein the one or more results associated with the matched transactions indicate the accuracy of the one or more clusters, based on the determined one or more confidence scores.

5. The ML-based method of claim 4, further comprising generating, by the one or more hardware processors, one or more actionable insights for the data reconciliation from the one or more results associated with the matched transactions, using the ML model, by:
obtaining, by the one or more hardware processors, fifth data associated with the one or more results corresponding to the matched transactions;
pre-processing, by the one or more hardware processors, the fifth data associated with the one or more results corresponding to the matched transactions, to generate pre-processed fifth data;
generating, by the one or more hardware processors, one or more prompts for the ML model for a process of instruction generation, per each identified cluster, wherein each prompt comprises information associated with at least one of: the matched transactions, the user exceptions, and learnings from historical instructions;
identifying, by the one or more hardware processors, at least one of: one or more patterns and one or more commonalities, by analyzing the data associated with the one or more results corresponding to the matched transactions; and
subsequently generating, by the one or more hardware processors, the one or more actionable insights and one or more instructions, based on at least one of: the one or more patterns and the one or more commonalities, using the ML model.

6. The ML-based method of claim 5, further comprising:
aggregating, by the one or more hardware processors, the one or more actionable insights and the one or more instructions, into a set of guidelines related to the matched transactions;
converting, by the one or more hardware processors, the set of guidelines related to the matched transactions, into at least one of: one or more details, one or more substrings, one or more keywords, and one or more identifiers;
validating, by the one or more hardware processors, the set of guidelines related to the matched transactions;
storing, by the one or more hardware processors, the set of guidelines related to the matched transactions, in the one or more databases;
learning, by the one or more hardware processors, the set of guidelines by the ML model from the one or more databases, for optimizing the data reconciliation; and
updating, by the one or more hardware processors, the one or more databases based on the optimized data reconciliation performed by the learned ML model.

7. The ML-based method of claim 2, wherein generating the one or more second rules for the rule model, comprises:
obtaining, by the one or more hardware processors, sixth data from the one or more databases, wherein the sixth data comprise information associated with the one or more clusters with the matched transactions, generated for the one or more subsequent matchings;
pre-processing, by the one or more hardware processors, the sixth data associated with the one or more clusters, to generate pre-processed sixth data;
generating, by the one or more hardware processors, one or more prompts for the ML model for a process of rule generation, per each cluster of the one or more clusters, wherein each prompt comprises information associated with at least one of: the one or more clusters, historical rules, and user exceptions;
generating, by the one or more hardware processors, one or more match criteria by analyzing one or more key dimensions comprising at least one of: a date field, an amount field, and a text field;
generating, by the one or more hardware processors, at least one of: one or more date tolerances, one or more amount patterns, and one or more text operators, for each key dimension; and
consolidating, by the one or more hardware processors, at least one of: the one or more date tolerances, the one or more amount patterns, and the one or more text operators, to generate the one or more second rules for the one or more subsequent matchings between the at least two datasets.

8. The ML-based method of claim 7, further comprising:
validating, by the one or more hardware processors, the one or more second rules for duplication of previously stored rules, based on one or more identifiers assigned to the one or more second rules;
determining, by the one or more hardware processors, whether the one or more results associated with the matched transactions exceed a pre-determined threshold value upon testing the validated one or more second rules on sample data; and
storing, by the one or more hardware processors, the validated one or more second rules in the one or more databases for future data reconciliation processes when the one or more results associated with the matched transactions exceed the pre-determined threshold value.

9. A machine learning based (ML-based) system for automatic data reconciliation, the ML-based system comprising:
one or more hardware processors; and
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain one or more inputs associated with first data from one or more databases, wherein the one or more inputs comprise at least one of: one or more entity-specific instructions and one or more historical matched records from at least two datasets;
a data pre-processing subsystem configured to pre-process the one or more inputs associated with the first data to generate pre-processed first data;
a rules generating subsystem configured to generate one or more first rules for a rule model using a machine learning (ML) model, based on the generated pre-processed first data;
a data processing subsystem configured to:
apply the generated one or more first rules for matching the at least two datasets using the rule model to determine second data between the at least two datasets, wherein the second data comprise matched data between the at least two datasets; and
process third data for one or more subsequent matchings among the at least two datasets, to generate at least one of: one or more matching suggestions, one or more confidence scores, and one or more reasonings for the one or more matching suggestions, during each subsequent match, using the ML model, wherein the third data comprise unmatched data between the at least two datasets;
the rules generating subsystem configured to generate one or more second rules for the rule model, upon performing the one or more subsequent matchings using at least one of: the ML model and one or more users;
a rules updating subsystem configured to update the rule model based on correlation between the one or more first rules and the one or more second rules; and
an output subsystem configured to provide data reconciliation between the at least two datasets based on the updated rule model, as an output to the one or more users through one or more interfaces associated with one or more electronic devices of the one or more users.

10. The ML-based system of claim 9, wherein in processing the third data for one or more subsequent matchings among the at least two datasets, the data processing subsystem is configured to:
obtain the at least two datasets with a set of configurations, wherein the set of configurations comprise one or more threshold values for date and amount differences, for determining one or more matches;
pre-process the third data associated with the at least two datasets, to generate pre-processed third data;
cluster transactions within the at least two datasets into one or more clusters, using the ML model; and
validate an accuracy of the one or more clusters using the transactions matched between the at least two datasets.

11. The ML-based system of claim 10, wherein in clustering the transactions within the at least two datasets, using the ML model, the data processing subsystem is configured to:
perform a one-to-one matching process between the transactions within the at least two datasets;
group the transactions by date and amount to identify the one or more clusters wherein a single transaction in a first dataset of the at least two datasets corresponds to a single transaction in a second dataset of the at least two datasets by applying an inner merge technique;
perform at least one of: a one-to-many matching process and a many-to-one matching process, to identify the one or more clusters wherein the single transaction in the first dataset corresponds to multiple transactions in the second dataset by applying combinatorial search techniques; and
perform a many-to-many matching process to identify the one or more clusters wherein the multiple transactions in the first dataset correspond to the multiple transactions in the second dataset by applying advanced combinatorial search techniques.

12. The ML-based system of claim 10, wherein in validating an accuracy of the one or more clusters with the matched transactions between the at least two datasets, the data processing subsystem is configured to:
obtain fourth data associated with the matched transactions, from the one or more clusters;
pre-process by the one or more hardware processors, the fourth data associated with the matched transactions to generate pre-processed fourth data;
generate one or more prompts for the ML model to determine confidence score per each identified cluster, wherein each prompt comprises information associated with at least one of: the matched transactions, user exceptions, and learnings from historical matched transactions;
generate the one or more reasonings for the one or more confidence scores for each identified cluster with the one or more reasonings; and
optimize a reliability of one or more results associated with the matched transactions, based on the determined one or more confidence scores, wherein the one or more results associated with the matched transactions indicate the accuracy of the one or more clusters, based on the determined one or more confidence scores.

13. The ML-based system of claim 12, further comprising an insights generating subsystem configured to generate one or more actionable insights for the data reconciliation from the one or more results associated with the matched transactions, using the ML model, by:
obtain fifth data associated with the one or more results corresponding to the matched transactions;
pre-process the fifth data associated with the one or more results corresponding to the matched transactions, to generate pre-processed fifth data;
generate one or more prompts for the ML model for a process of instruction generation, per each identified cluster, wherein each prompt comprises information associated with at least one of: the matched transactions, the user exceptions, and learnings from historical instructions;
identify at least one of: one or more patterns and one or more commonalities, by analyzing the data associated with the one or more results corresponding to the matched transactions; and
subsequently generate the one or more actionable insights and one or more instructions, based on at least one of: the one or more patterns and the one or more commonalities, using the ML model.

14. The ML-based system of claim 13, wherein the insights generating subsystem is further configured to:
aggregate the one or more actionable insights and the one or more instructions, into a set of guidelines related to the matched transactions;
convert the set of guidelines related to the matched transactions, into at least one of: one or more details, one or more substrings, one or more keywords, and one or more identifiers;
validate the set of guidelines related to the matched transactions;
store the set of guidelines related to the matched transactions, in the one or more databases;
learn the set of guidelines by the ML model from the one or more databases, for optimizing the data reconciliation; and
update the one or more databases based on the optimized data reconciliation performed by the learned ML model.

15. The ML-based system of claim 10, wherein in generating the one or more second rules for the rule model, the rules generating subsystem is configured to:
obtain sixth data from the one or more databases, wherein the sixth data comprise information associated with the one or more clusters with the matched transactions, generated for the one or more subsequent matchings;
pre-process the sixth data associated with the one or more clusters, to generate pre-processed sixth data;
generate one or more prompts for the ML model for a process of rule generation, per each cluster of the one or more clusters, wherein each prompt comprises information associated with at least one of: the one or more clusters, historical rules, and user exceptions;
generate one or more match criteria by analyzing one or more key dimensions comprising at least one of: a date field, an amount field, and a text field;
generate at least one of: one or more date tolerances, one or more amount patterns, and one or more text operators, for each key dimension; and
consolidate at least one of: the one or more date tolerances, the one or more amount patterns, and the one or more text operators, to generate the one or more second rules for the one or more subsequent matchings between the at least two datasets.

16. The ML-based system of claim 15, wherein the rules generating subsystem is further configured to:
validate the one or more second rules for duplication of previously stored rules, based on one or more identifiers assigned to the one or more second rules;
determine whether the one or more results associated with the matched transactions exceed a pre-determined threshold value upon testing the validated one or more second rules on sample data; and
store the validated one or more second rules in the one or more databases for future data reconciliation processes when the one or more results associated with the matched transactions exceed the pre-determined threshold value.

17. A non-transitory computer-readable storage medium having instructions stored therein that when executed by one or more hardware processors, cause the one or more hardware processors to execute operations of:
obtaining one or more inputs associated with first data from one or more databases, wherein the one or more inputs comprise at least one of: one or more entity-specific instructions and one or more historical matched records from at least two datasets;
pre-processing the one or more inputs associated with the first data to generate pre-processed first data;
generating one or more first rules for a rule model using a machine learning (ML) model, based on the generated pre-processed first data;
applying the generated one or more first rules for matching the at least two datasets using the rule model to determine second data between the at least two datasets, wherein the second data comprise matched data between the at least two datasets;
processing third data for one or more subsequent matchings among the at least two datasets, to generate at least one of: one or more matching suggestions, one or more confidence scores, and one or more reasonings for the one or more matching suggestions, during each subsequent match, using the ML model, wherein the third data comprise unmatched data between the at least two datasets;
generating one or more second rules for the rule model, upon performing the one or more subsequent matchings using at least one of: the ML model and one or more users;
updating the rule model based on correlation between the one or more first rules and the one or more second rules; and
providing data reconciliation between the at least two datasets based on the updated rule model, as an output to the one or more users through one or more interfaces associated with one or more electronic devices of the one or more users.

18. The non-transitory computer-readable storage medium of claim 17, wherein processing the third data for one or more subsequent matchings among the at least two datasets, comprises:
obtaining the at least two datasets with a set of configurations, wherein the set of configurations comprise one or more threshold values for date and amount differences, for determining one or more matches;
pre-processing the third data associated with the at least two datasets, to generate pre-processed third data;
clustering transactions within the at least two datasets into one or more clusters, using the ML model; and
validating an accuracy of the one or more clusters using the transactions matched between the at least two datasets.

19. The non-transitory computer-readable storage medium of claim 17, further comprising generating one or more actionable insights for the data reconciliation from the one or more results associated with the matched transactions, using the ML model, by:
obtaining fifth data associated with the one or more results corresponding to the matched transactions;
pre-processing the fifth data associated with the one or more results corresponding to the matched transactions, to generate pre-processed fifth data;
generating one or more prompts for the ML model for a process of instruction generation, per each identified cluster, wherein each prompt comprises information associated with at least one of: the matched transactions, the user exceptions, and learnings from historical instructions;
identifying at least one of: one or more patterns and one or more commonalities, by analyzing the data associated with the one or more results corresponding to the matched transactions; and
subsequently generating the one or more actionable insights and one or more instructions, based on at least one of: the one or more patterns and the one or more commonalities, using the ML model.

20. The non-transitory computer-readable storage medium of claim 18, wherein generating the one or more second rules for the rule model, comprises:
obtaining sixth data from the one or more databases, wherein the sixth data comprise information associated with the one or more clusters with the matched transactions, generated for the one or more subsequent matchings;
pre-processing the sixth data associated with the one or more clusters, to generate pre-processed sixth data;
generating one or more prompts for the ML model for a process of rule generation, per each cluster of the one or more clusters, wherein each prompt comprises information associated with at least one of: the one or more clusters, historical rules, and user exceptions;
generating one or more match criteria by analyzing one or more key dimensions comprising at least one of: a date field, an amount field, and a text field;
generating at least one of: one or more date tolerances, one or more amount patterns, and one or more text operators, for each key dimension; and
consolidating at least one of: the one or more date tolerances, the one or more amount patterns, and the one or more text operators, to generate the one or more second rules for the one or more subsequent matchings between the at least two datasets.
